(19) United States
(12) Patent Application Publication
(10) Pub. No.: US 2009/0191892 A1
(43) Pub. Date: Jul. 30, 2009

(54) INTEGRATING POSITION-DETERMINING AND WI-FI FUNCTIONS

(75) Inventor: Sean V. Kelley, Olathe, KS (US)

Correspondence Address: GARMIN LTD.;C/O GARMIN INTERNATIONAL, INC., ATTN: Legal - IP, 1200 EAST 151ST STREET, OLATHE, KS, 66062, US

(73) Assignee: GARMIN LTD., George Town (KY)

(21) Appl. No.: 12/020,421

(22) Filed: Jan. 25, 2008

(51) Int. Cl. H04Q 7/20

(52) U.S. Cl. 455/456.1; 455/41.2

(57) ABSTRACT

Techniques are described for leveraging position-determining functions and Wi-Fi functions on a device by integrating these functions. In one or more implementations, Wi-Fi data is provided on a electronic device configured with Wi-Fi and position-determining functionality. This Wi-Fi data is then used to facilitate the device accessing a Wi-Fi network available within a geographical region associated with the device. In at least some implementations, the facilitating is associated with identifying and/or selecting one or more potential Wi-Fi networks to access by integrating the Wi-Fi data with received positioning data and map data on the device. In at least some embodiments, the facilitating is associated with communicatively linking to a selected Wi-Fi network.

### BACKGROUND

Traditional wired networks may present significant limitations with respect to providing access to mobile devices because they require these mobile devices to be physically connected. As such, wireless networks, such as wireless fidelity (Wi-Fi) networks, are becoming increasingly popular. Additionally, devices configured with functionality to access these Wi-Fi networks, such as smart phones, personal digital assistant (PDA), laptops and the like, are becoming increasingly popular as well. Many of these devices are also configured with position-determining functionality allowing them to calculate their position and provide navigational instructions. Unfortunately however, these functions are typically not leveraged effectively.

### SUMMARY

Techniques are described for leveraging position-determining functions and Wi-Fi functions on a device by integrating these functions to provide a variety of useful features. In one or more implementations, Wi-Fi data is provided on an electronic device configured with Wi-Fi and position-determining functionality. This Wi-Fi data is then used to facilitate the device accessing a Wi-Fi network available within a geographical region associated with the device.

In at least some implementations, the facilitating is associated with identifying and/or selecting one or more potential Wi-Fi networks to access. This is accomplished by integrating Wi-Fi data with received positioning data and map data on the device to identify potential Wi-Fi networks that have, or are likely to have, a coverage area which includes the device's current position and/or another position in the geographical region. The device may then prompt the user to select one or more of the potential Wi-Fi hotspots to access and, in some implementations, be provided with information to assist selection. Alternatively or additionally, one or more Wi-Fi networks may be automatically selected by the device based on selection-related information.

Furthermore, in at least some embodiments, the facilitating is associated with communicatively linking to a selected Wi-Fi network. This may include integrating the Wi-Fi data with received positioning data and map data on the device to prompt the user to communicatively link the device with a selected Wi-Fi network, provide the user with instructions to assist in navigating to a position within the coverage area of the selected Wi-Fi network, and/or automatically link the device with the selected Wi-Fi network.

This Summary is provided solely to introduce subject matter that is fully described in the Detailed Description and Drawings. Accordingly, the Summary should not be considered to describe essential features nor be used to determine the scope of the claims.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 depicts an exemplary environment in which the described techniques for integrating position-determining and Wi-Fi functions on a device may be employed.

FIG. 2 depicts an exemplary implementation of the electronic device shown in the environment of FIG. 1 in greater detail.

FIG. 3 depicts an exemplary geographical region associated with the described techniques for integrating position-determining and Wi-Fi functions.

FIG. 4 depicts a procedure in an exemplary implementation in which a device configured with Wi-Fi and position-determining functionality may facilitate identifying and selecting one or more Wi-Fi networks to access.

FIG. 5 depicts a procedure in an exemplary implementation in which a device configured with Wi-Fi and position-determining functionality may facilitate communicatively linking with a selected Wi-Fi hotspot.

### DETAILED DESCRIPTION

### Exemplary Environment

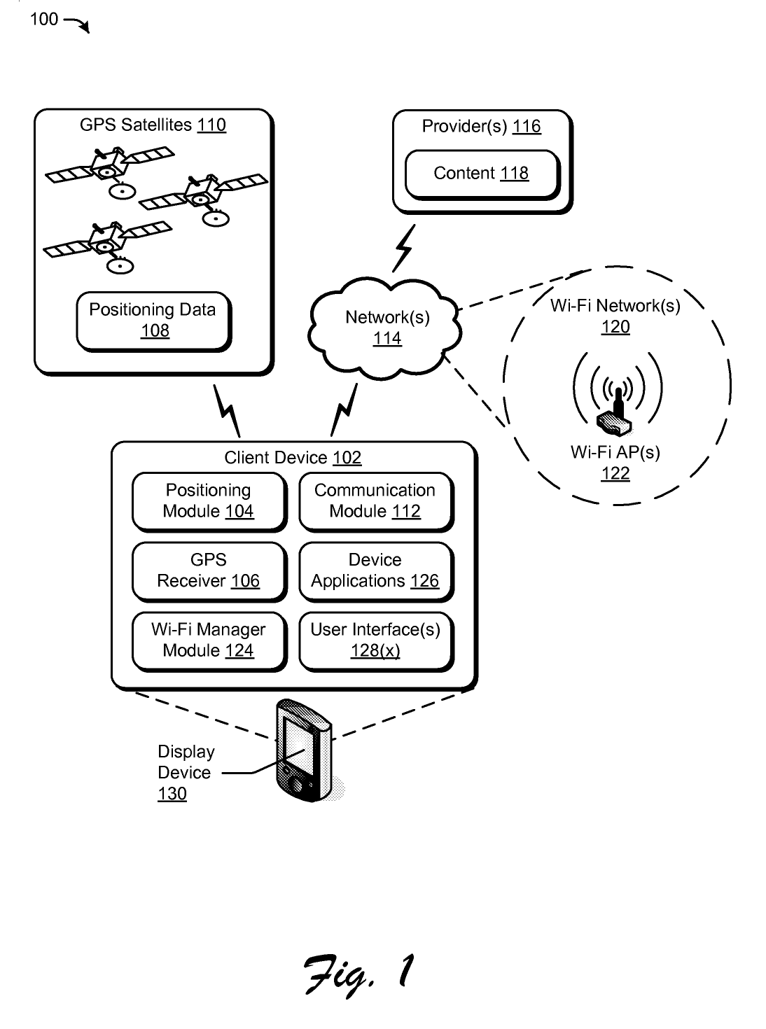

FIG. 1 illustrates an exemplary environment in which the described techniques for integrating position-determining and Wi-Fi functions on a device may be employed. In this example, environment 100 includes electronic device 102 which is configured to provide a variety of functionality through various application modules and operations. Electronic device 102 may be configured as any suitable type of device or devices such as, without limitation, a mobile phone, smart phone, personal computer, laptop, position-determining device, personal digital assistant, multimedia device, game device and/or any combination thereof. In at least some implementations, electronic device 102 is a mobile phone configured with global positioning satellite (GPS) position-determining functionality and Wi-Fi functionality. In the following description a referenced component, such as electronic device 102, may refer to one or more entities, and therefore by convention reference may be made to a single entity (e.g., electronic device 102) or multiple entities (e.g., electronic devices 102—the plurality of electronics 102) using the same reference number.

In this example, electronic device 102 includes a positioning module 104 which is representative of position-determining functionality associated with managing and processing positioning information to determine a position for electronic device 102. More particularly, electronic device 102 is depicted here as including a GPS receiver 106 associated with functionality to receive positioning data 108 from GPS satellites 110. Received positioning data 108 may then be managed and processed by positioning module 104 to determine/calculate a current position of the electronic device 102 in the context of map data associated with and describing a geographical region that includes the electronic device's current position. Here, it should be noted that while a GPS system is described and illustrated in relation to FIG. 1, a wide variety of other positioning systems may also be employed, such as other Global Navigation Satellite Systems (GNSS), terrestrial based systems (e.g., wireless-phone based systems that broadcast positioning data from cellular towers), wireless networks that transmit positioning signals, and the like. For example, positioning-determining functionality may be implemented through the use of a server in a server-based architecture, from a ground-based infrastructure, through one or more sensors (e.g., gyros, odometers, magnetometers), use of “dead reckoning” techniques, and so on.

Electronic device 102 also includes a communication module 112 which is representative of communication functionality to permit electronic device 102 to send/receive data between different devices (e.g., components/peripherals) and/or over one or more networks 114. This may include, without limitation, sending/receiving data over one or more cellular networks and/or over one or more internet protocol (IP)-based data networks. As such, electronic device 102, through communication functionality represented by communication module 112, may be configured to communicate via one or more networks 114 with one or more data providers 116 to receive or otherwise interact with content 118. Communication module 112 is representative of a variety of suitable communication components and functionality. By way of example and not limitation, this may include antennas, browsers, transmitters and/or receivers, radios, data ports, software interfaces and drivers, networking interfaces, data processing components, and the like.

One or more networks 114 are representative of a variety of suitable networks and network connections that may be employed, individually or in combination to communicate among the various components of environment 100. Thus, one or more networks 114 may be representative of communication pathways achieved using a single network or multiple networks. By way of example and not limitation, suitable networks and network communications may include the internet, local area networks (LANs), wide area networks (WANs), cellular voice and/or data networks or the like; and be accessible via any combination of wired, backhaul and/or wireless network communication pathways. As such, one or more networks 114 may include and/or be accessed by wireless networks and network communications that employ Wi-Fi technology owned by the Wi-Fi alliance. These Wi-Fi networks, which may adhere to 802.11 standards developed by the Institute of Electrical and Electronics Engineers (IEEE), are becoming increasingly popular and are often used by devices to access other networks such as the internet. Here, one or more Wi-Fi networks 120 are representative of such networks.

Suitably configured and authorized devices, such as electronic device 102 for instance, may wirelessly access a particular Wi-Fi network of one or more Wi-Fi networks 120 by communicatively linking with one or more Wi-Fi access points (AP)s 122. Communicatively linking may include electronic device 102 sending and/or receiving data over the particular Wi-Fi network and/or one or more associative actions taken by electronic device 102 and/or Wi-Fi AP(s) associated with the particular Wi-Fi network to allow for the sending and/or receiving. Specifically, each of one or more Wi-Fi APs 122 is configured to communicate (i.e., send and/or receive data), using Wi-Fi technology and other modulation techniques, with suitable devices within its transmission range, or coverage area. The collective coverage area of one or more Wi-Fi APs 122 for a particular Wi-Fi network defines a Wi-Fi hotspot corresponding to that particular Wi-Fi network. As such, individual Wi-Fi hotspots provide a geographical coverage area, or range of transmission of one or more corresponding Wi-Fi APs. Here the one or more Wi-Fi hotspots associated with one or more Wi-Fi networks 120 are collectively represented by a dashed circle enclosing one or more Wi-Fi networks 120 and Wi-Fi APs 122.

In accordance with the integrating techniques described herein, electronic device 102 also includes Wi-Fi manger module 124 to manage and process various types of data including data associated with various Wi-Fi networks. As is described in more detail below, Wi-Fi manager module 124 is representative of functionality associated with managing and processing data associated with various Wi-Fi networks and integrating this data with received positioning data 108 and map data on electronic device 102. For example, Wi-Fi data may be utilized with positioning data 108 and map data to facilitate identification and/or selection of a potential Wi-Fi network or set of potential Wi-Fi networks to access in a geographical region depicted and/or described by the map data, further discussion of which may be found below. In another example, Wi-Fi data may be utilized with positioning data 108 and map data to facilitate communicatively linking with a selected Wi-Fi network, further discussion of which may also be found below.

To provide a variety of functionality, such as the described position-determining, communication and integrating functionality, electronic device 102 may include a variety of device applications, designated here as device applications 126. For example, positioning module 104 may be considered a device application that is related to determining/calculating the current position of electronic device 102. As another example, Wi-Fi manager module 124 may be considered a device application that is related to prompting, notifying, presenting information and/or automatically performing one or more actions on electronic device 102 associated with selecting and/or communicatively linking with one or more Wi-Fi networks. Additionally, device applications 126 may operate to form one or more corresponding user interfaces 128(x) that may be visually output via display device 130 and/or audibly output via a speaker apparatus (not shown) to allow a user to interact with electronic device 102.

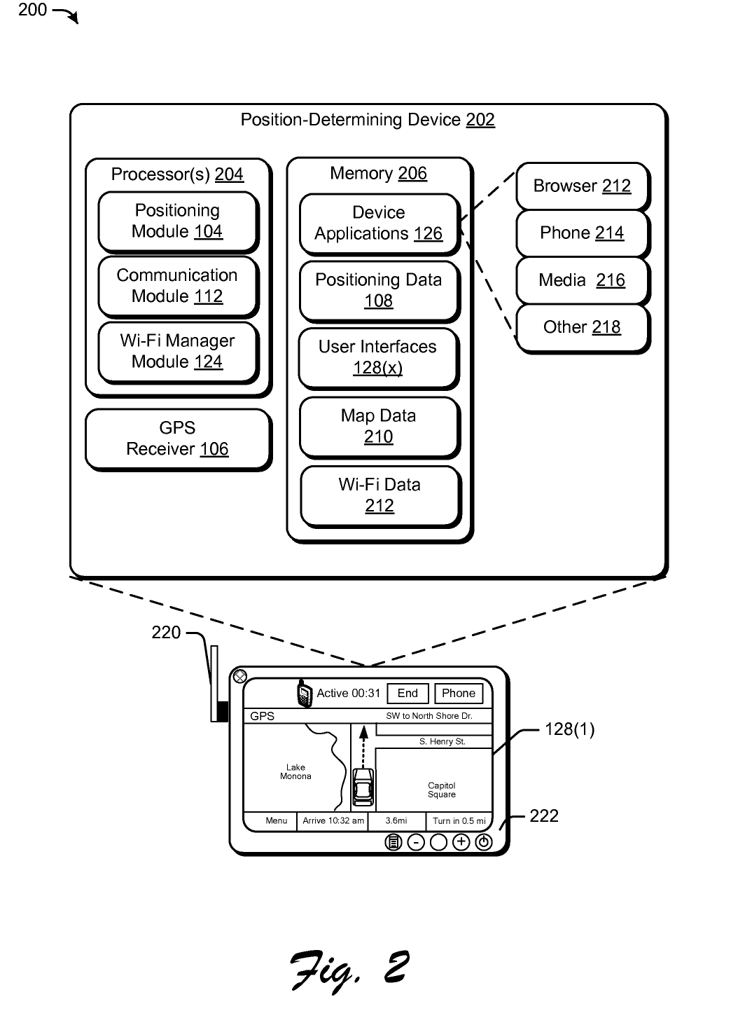

FIG. 2 illustrates a detailed example of electronic device 102 of FIG. 1 in the context of position-determining device 202. In this example, position-determining device 202 includes one or more respective processors 204 and memory 206 which may be utilized to provide a variety of processing and storage capabilities. One or more processors 204 are not limited by the materials from which they are formed or the processing mechanisms employed therein, and as such, may be implemented via semiconductor(s) and/or transistors (e.g., electronic integrated circuits (ICs)) and so forth. Additionally, although a single memory 206 is shown for position-determining device 202, a wide variety of types and combinations of memory may be employed, such as random access memory (RAM), removable medium memory (e.g., memory 206 may be implemented via a slot that accepts a removable memory card or cartridge), hard disk memory, and other types of computer-readable media.

In this example, positioning module 104, communication module 112 and Wi-Fi manager module 124 are illustrated as being executable via one or more processors 204 and are storable in memory 206. Additionally, memory 206 is illustrated as storing various device applications 126, positioning data 108, map data 210, Wi-Fi data 212 and user interfaces 128(x). This data may be locally maintained by positioning-determining device 202 in any suitable form and be received via any suitable means. Furthermore, user interfaces 128(x) may be formed and output via any suitable application, including one or more of device applications 126 for instance.

Additional device applications 126 are illustrated as including browser application 212, phone application 214, and media application 216. For instance, browser application 212 may represent functionality executable on one or more processors 204 to receive or otherwise interact with content 118 from provider 116 of FIG. 1, such as to receive all or part of map data 210 and/or Wi-Fi data 212, email services, instant messaging services, view web pages and other content. Phone application 214 may represent functionality executable on one or more processors 204 to obtain phone service from a cellular provider, such as to make and receive mobile phone calls, manage contacts, send/receive text messages, and in some implementations even receive all or part of map data 210 and/or Wi-Fi data 212. Media application 216 may represent functionality executable on one or more processors 204 to manage a media library that may include music files, photos, videos, media metadata and the like. A variety of other applications 218 may also be included to provide additional functionality to position-determining device 202 as well.

For the purposes of this discussion, the position-determining functionality of position-determining device 202 may relate to a variety of different navigation techniques and other techniques that may be supported by “knowing” one or more positions. For instance, position-determining functionality may be employed to provide location information, timing information, speed information, direction of movement and a variety of other navigation-related data. Accordingly, position-determining device 202 may be configured in a variety of ways to perform a wide variety of functions. For example, positioning-determining device 202 may be configured for outdoor navigation, vehicle navigation, aerial navigation (e.g., for airplanes, helicopters), marine navigation and so forth. Accordingly, position-determining device 202 may include a variety of devices to determine position using one or more of the described techniques.

In this regard, positioning module 104 may be executed to use received positioning data 108 in combination with map data 210 stored in memory 206 to generate navigational instructions (e.g., turn-by-turn instructions to a destination point or points), show a current position on a map and so on. To receive positioning data 108, as well as to perform other communications—such as communicating via one or more networks 114 for instance, position-determining device 202 may include one or more antennas 220. Positioning module 104 may also be executed to provide other position-determining functionality, such as to determine a current speed, direction, calculate an arrival time and so on.

With respect to receiving user input, position-determining device 202 may be configured to receive input, thus allowing a user interact with the various functions of position-determining device 202. For example, position-determining device 202 may be configured with a touch-screen that is responsive to direct touch. Accordingly, user interfaces 128(x) may be configured to define selectable areas of the touch-screen to perform one or more of these various functions. In addition, various input controls 222 such as buttons, dials, microphones and the like may be provided to receive additional types of user input.

As noted above, Wi-Fi manager module 124 is representative of functionality associated with integrating position-determining functions and Wi-Fi functions. In operation, Wi-Fi manager module 124 may be configured to integrate positioning data 108, map data 210 and Wi-Fi data 212 to facilitate identifying, selecting and/or communicatively linking with one or more Wi-Fi networks. In this regard, Wi-Fi manager module 124 may automatically perform integration-related operations continuously and/or responsive to a particular event. Without limitation, such an event may include the user interacting with position-determining device 202 via one or more corresponding user interfaces 128(x), position-determining device 202 entering/leaving a particular geographical region depicted/described by map data 210 and/or position-determining device 202 receiving a transmitted signal/beacon from one or more Wi-Fi APs.

By way of example and not limitation, in some implementations, integration operations may include Wi-Fi manager module 124 (and potentially one or more other modules on position-determining device 202) utilizing positioning data 108 and map data 210 to identify a geographical region on a map that includes the current position of position-determining device 202 and present/output this on user interface 128(1). Wi-Fi manager module 124 may then utilize Wi-Fi data 212 and map data 210 to identify any Wi-Fi APs/hotspots located in the identified geographical region and their respective coverage areas. Furthermore, since the current position of position-determining device 202 is located in the identified geographical region, Wi-Fi manager module 124 may determine whether position-determining device 202 is in or out-of the expected coverage range of one or more of the identified Wi-Fi APs/hotspots. In addition, since information associated with the position-determining device's current speed and direction of movement is available from positioning module 112, Wi-Fi manager module 124 may also determine when it is expected to be entering or leaving an expected coverage range of one or more Wi-Fi APs/hotspots (i.e., by relying on a pre-defined distance from a coverage range border for instance).

Continuing, position-determining device 202 may perform various operations in response identification of one or more Wi-Fi APs/hotspots. By way of example and not limitation, this may include notifying and/or prompting the user via any suitable means, such as visually displaying/outputting this information via user interface 128(1) and/or audibly outputting this information via a speaker apparatus (not shown). In this regard, a wide variety of notifications and/or prompts are contemplated. By way of example and not limitation, this can include prompting the user when position-determining device 202 enters an expected coverage area so that the user may search for a Wi-Fi hotspot to access. As such, the user might then cause position-determining device 202 to determine which, if any, identified Wi-Fi APs/hotspots are actually communicatively available (i.e., are currently sending signals over the coverage area which includes position-determining device 202).

As another example, the user may be prompted to select an identified Wi-Fi hotspot to access and even be provided with useful selection-related information to aid selection. Alternatively or additionally, position-determining device 202 may perform various operations which include automatically selecting one or more identified Wi-Fi APs/hotspots to access. In at least some implementations, this selection may be based on user preferences associated with certain information—such as the selection-related information mentioned above.

Similarly, and by way of example and not limitation, in some implementations integration operations may be associated with communicatively linking position-determining device 202 with a selected Wi-Fi AP(s)/hotspot. This may include Wi-Fi manager module 124 causing position-determining device 202 to prompt the user (via interface 128(1) for instance) to communicatively link with a selected Wi-Fi AP/hotspot or causing position-determining device 202 to automatically link the position-determining device 202 with the selected Wi-Fi AP/hotspot. Additionally or alternatively, in some implementations position-determining device 202 may utilize positioning data 108 and map data 210 to generate and output instructions (e.g., turn-by-turn instructions) on user interface 128(1) for navigating from the position-determining device's current position to one or more destination positions/points within the coverage area of one or more selected Wi-Fi APs/hotspots. For example, the position-determining device 202 may calculate a route through a city based on its current geographical position and the position of one or more identified hotspots to maximize the time in which the device 202 is within the coverage area of the one or more hotspots. Further discussion regarding integration operations associated with communicatively linking may be found below.

Here, it should be noted that any of the functions described herein may be implemented using software, firmware, hardware (e.g., fixed logic circuitry), manual processing, or a combination thereof. The terms “module” and “functionality” as used herein generally represent software, firmware, hardware or a combination thereof. In the case of a software implementation, for instance, a module represents executable instructions that perform specified tasks when executed on a processor, such as one or more processors 204 for instance. The program code may be stored in one or more computer-readable media, such as memory 206 for instance.

### Exemplary Implementation

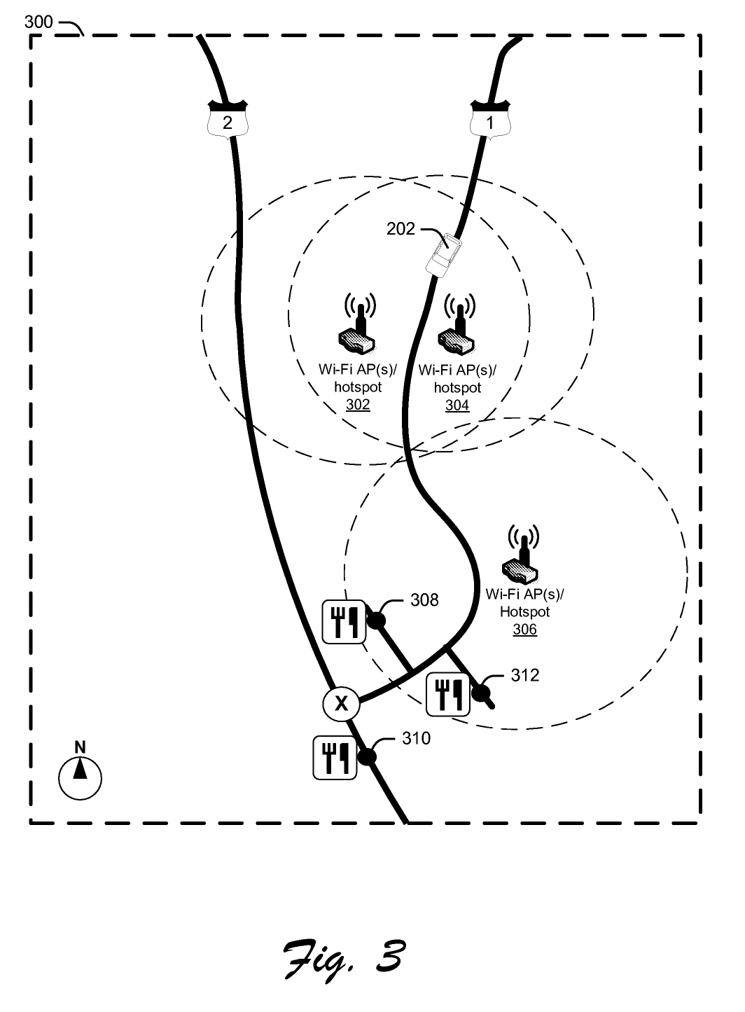

As described above, Wi-Fi data may be provided on a device, such as electronic device 102 above, to facilitate identifying, selecting and/or communicatively linking with one or more Wi-Fi networks available within a geographical region associated with the device. As but one example of this, consider FIG. 3 which illustrates such a geographical region, here designated geographical region 300. For purposes of discussion, geographical region 300 is described here in the context of environment 200 and position-determining device 202 of FIG. 2. However, it is to be appreciated and understood that the described techniques may be implemented by any suitable environment without departing from the spirit and scope of the claimed subject matter.

Here, geographical region 300 is illustrated as including position-determining device 202 which in this example is depicted as being located in a vehicle at a current position along route 1—which is one of two potential routes (the other designated route 2) leading to destination point X. Note that by virtue of having the above described GPS receiver, modules, application(s) and interface(s), position-determining device 202 includes the above-described functionality for position-determining, communicating and integrating. As such, position-determining device 202 may receive positioning data associated with its position and thus identify geographical region 300 with respect to relevant map data such that it “knows” its current location in geographical region 300. Furthermore, by virtue of having accessible Wi-Fi data, position-determining device 202 may identify potential Wi-Fi networks and their respective coverage areas located in geographical region 300. As such, position-determining device 202 is capable of determining which potential Wi-Fi networks, if any, have coverage areas which include, or are likely to include the current position of position-determining device 202 and/or some other position within geographical region 300. By way of example and not limitation, position-determining device 202 may utilize Wi-Fi data to search for hotspots based on its current position and/or another position that is provided via one or more user interface(s) 128(x).

As described in more detail below, position-determining device 202 may be configured to identify potential Wi-Fi networks and their respective coverage areas. Here, three identified potential Wi-Fi networks and their respective coverage areas are designated by their respective Wi-Fi APs/hotspots, namely Wi-Fi AP(s)/hotspot 302, Wi-Fi AP(s)/hotspot 304 and Wi-Fi AP(s)/hotspot 306. As described above, each of these Wi-Fi AP(s)/hotspots is located within geographical region 300 and is associated with a respective coverage area, or transmission range, depicted by a dashed circle. Furthermore, note that position-determining device 202 is currently at a position within the coverage area of Wi-Fi AP(s)/hotspot 302 and Wi-Fi AP(s)/hotspot 304, but outside of the coverage area of Wi-Fi AP(s)/hotspot 306. Nevertheless, by utilizing the described integrating techniques, position-determining device 202 is still able to identify Wi-Fi AP(s)/hotspot 306 (including its coverage area) relative to position-determining device 202 in geographical region 300 (i.e., generally to the South of the position-determining device's current position).

Continuing, position-determining device 202 may be configured to prompt the user to select an identified Wi-Fi AP(s)/hotspot to access and even provide information to assist in user selection. For example, position-determining device 202 may prompt the user to select one of the Wi-Fi AP(s)/hotspots that are communicatively available (i.e., Wi-Fi AP(s)/hotspot 302 and 304) and/or provide selection-related information about each. This selection-related information can be provided in any suitable way, such as by outputting it via one or more user interface(s) 128(x) for instance, and can include any information that is potentially useful to the user. For example, individual Wi-Fi AP(s)/hotspots and their coverage areas might be presented on a map via one or more user interface(s) 128(x). Alternatively or additionally, other information such as Wi-Fi AP(s)/hotspot provider information, fee information, security/authentication information and so forth may be presented. For discussion purposes, assume here that Wi-Fi AP(s)/hotspot 302 is associated with a fee while Wi-Fi AP(s)/hotspot 304 is not. Using this information, if the user prefers a free Wi-Fi network, they may select Wi-Fi AP(s)/hotspot 304 and then cause position-determining device 202 to communicatively link with it. In addition, as explained above, position-determining device 202 may also prompt or otherwise allow the user to discover that Wi-Fi AP(s)/hotspot 306 is located within geographical region 300—despite the fact that position-determining device 202 is not within the coverage area of Wi-Fi AP(s)/hotspot 306. In this regard, useful information about Wi-Fi AP(s)/hotspot 306, such as its coverage area, cost, security/authentication and so forth may also be provided to the user. Furthermore, position-determining device 202 may even provide the user with turn-by-turn instructions for navigating to a position within the coverage area Wi-Fi AP(s)/hotspot 306, such as directions to continue southward on Route 1 for instance.

Alternatively or additionally, in at least some implementations position-determining device 202 may be configured to automatically select a Wi-Fi AP(s)/hotspot to access based on Wi-Fi AP(s)/hotspot information and/or user preferences. As an example, position-determining device 202 may automatically select and communicatively link with Wi-Fi hotspot 304 by virtue of certain user preferences indicating that a Wi-Fi hotspot with no cost or one provided by a specific provider should be selected if possible. As such, in these circumstances, position-determining device 202 could automatically select Wi-Fi AP(s)/hotspot 304 and then cause position-determining device 202 to communicatively link with it.

As noted above, geographical region 300 is illustrated as including two potential routes (routes 1 and 2) leading to destination point X. As such, by virtue of the described integration techniques, position-determining device 202 is capable of providing the user with information associated with which Wi-Fi AP(s)/hotspot(s), if any, are likely to be available from points along each of these routes before the user embarks on their journey. In addition, as will be understood and appreciated by those skilled in the art, position-determining device 202 may provide the user with other types of information, such as weather information and/or information about goods and/or services located/available at certain points along each route. Using this information, the user may select a route to destination point X. Here for example, assume that the user has selected route 1 (from possible routes 1 and 2) at least in part because route 1 is associated with more positions likely to be within the coverage area of a Wi-Fi AP(s)/hotspot and/or because route 1 is associated with a no-charge Wi-Fi AP(s)/hotspot, namely Wi-Fi AP(s)/hotspot 304, while route 2 is not.

In addition to providing information to assist the user in selecting a route to a destination point, position-determining device 202 may also provide the user with information to assist in identifying one or more points of interest (POI)s and/or selecting one or more as a destination point (i.e., a via-point or one of several way-points). Additionally or alternatively, the user may effectively identify/designate a certain POI as a via point or way point based, at least in part, on whether it is located within the coverage area of a Wi-Fi AP(s)/hotspot they wish to access and/or whether it is associated with a desirable good or service. For example, here position-determining device 202 may inform the user that POIs 308 and 310 are restaurants serving Italian food while POI 312 is a restaurant serving French food. In addition, position-determining device 202 may inform the user that POIs 308 and 312 are likely to be within the coverage area of Wi-Fi AP/hotspot 306 while POI 310 is not. Using this information, if the user prefers a restaurant serving Italian food that is within a Wi-Fi hotspot, they may select POI 308 as a single destination point (i.e., a way-point) or even one of several destination points (i.e., a via-point) along a route.

### Exemplary Procedures

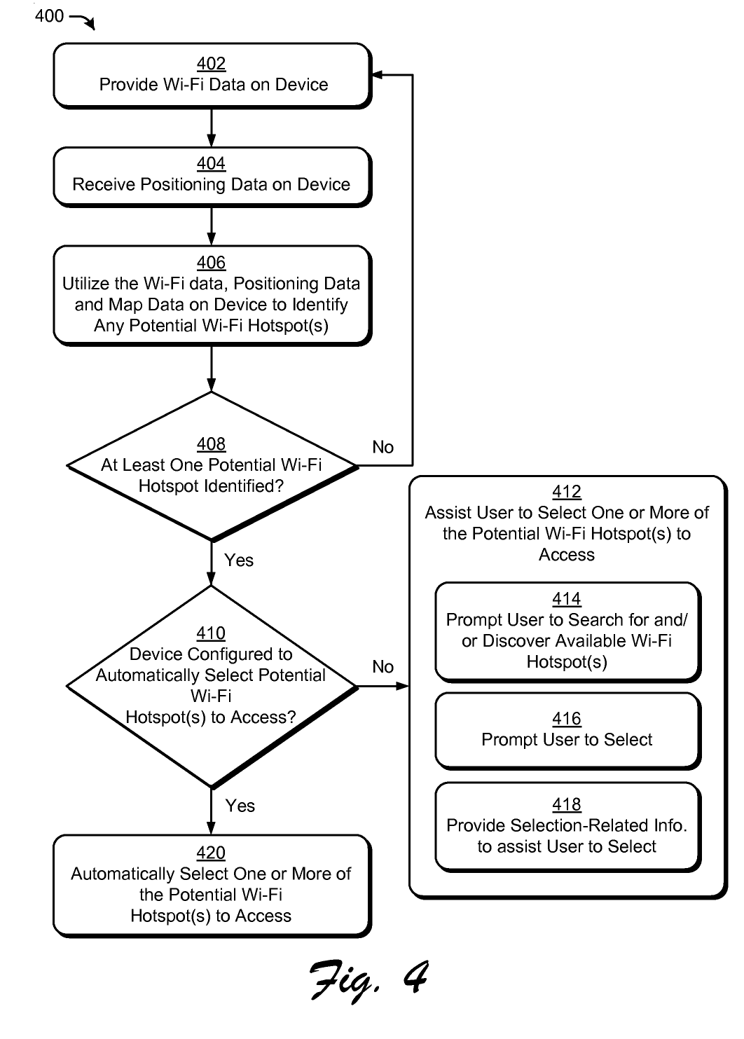

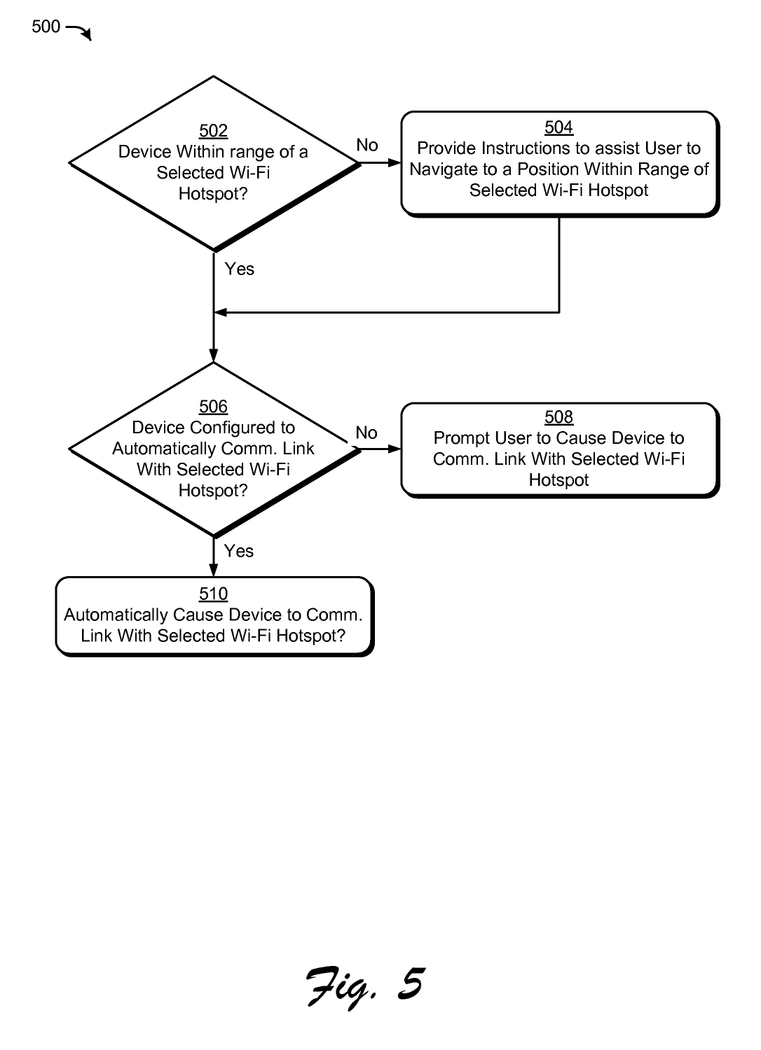

The following discussion of FIGS. 4 and 5 describes techniques for effectively integrating position-determining and Wi-Fi functions that may be implemented on a device utilizing the previously described systems and devices. Aspects of each of these procedures may be implemented in hardware, firmware, software or any combination thereof. The procedures are shown as a set of blocks that specify operations performed by one or more devices and are not necessarily limited to the orders shown for performing the operations by the respective blocks. Furthermore, for discussion purposes, reference may be made to FIGS. 1 through 3 in various portions of the following discussion. However, it is to be appreciated and understood that this is not intended to limit the spirit and scope of the claimed subject matter. As such, the features described below are platform-independent, meaning that the described techniques may be implemented on a variety of commercial computing platforms having a variety of processors.

FIG. 4 depicts procedure 400 of an exemplary implementation in which a device configured with Wi-Fi and position-determining functionality may facilitate identifying and selecting one or more Wi-Fi networks to access. At block 402, Wi-Fi data is provided on the device. This data, such as Wi-Fi data 212 on position-determining device 202, may include information about various Wi-Fi APs/hotspots and their respective Wi-Fi networks that is useful for identifying and/or selecting one or more of them to access. Specifically, this information may include details about individual Wi-Fi APs/hotspots such as, without limitation, their host (retail establishment, cellular carrier, government, etc.), cost (e.g., free, hourly charge, etc.), location (e.g., coordinates and/or address of Wi-Fi AP(s)), expected/typical coverage area/transmission range features, (e.g., geographical coordinates/boundaries, shape, obstructions, etc.), expected/typical transmission power, communicative availability, security/encryption (e.g., Wired Equivalent Privacy (WEP), Extensible Authentication Protocol (EAP), Wi-Fi Protected Access (WPA), IEEE 802.11, etc.) and device compatibility requirements, if any.

Continuing, this Wi-Fi data may be provided and stored on the device, or even a second device communicatively linked to the device (e.g., using Wi-Fi, cellular, BLUETOOTH technology or the like) in any suitable form and in any suitable manner such that this data may be indexed, queried, accessed and/or retrieved through any suitable means. By way of example and not limitation, this data may be provided on the device by automatically (e.g., continuously, at certain pre-defined time intervals or in response to an event) or manually downloading data content onto the device. In this regard, downloading may be accomplished by receiving information from any suitable source via any suitable means. For instance, data may be received via a suitable network and/or from a computer-readable volatile and/or non-volatile removable memory cartridges or the like via a slot or other connective feature on the device. Additionally or alternatively, this data may be provided and/or updated by a Wi-Fi radio or other suitable communication apparatus on the device suitable for detecting and/or receiving information from one or more Wi-Fi APs/hotspots communicatively available to the device, as will be appreciated and understood by those skilled in the art.

At block 404, positioning data is received on the device. As explained above, this data may include any suitable information (e.g. GPS signals) from any suitable source which allows the device its position-determining functionality. At block 406, the Wi-Fi data, positioning data and map data stored on the device is utilized to identify potential Wi-Fi hotspots. As will be appreciated and understood by those skilled in the art, this map data may be provided and stored on the device in any suitable form and in any suitable manner such that any combination of software, firmware, or a person may query, access and retrieve it. As described above, this may be accomplished by integrating the Wi-Fi and positioning data with the map data in a manner that allows Wi-Fi hotspots (and their respective coverage areas) in a certain geographical area (defined by the map data) to be located, considered and even output/presented in the context of the received positioning data and surrounding geographical features. As such, functionality on the device, such as is represented in Wi-Fi manager module 124 above for instance, may be used to identify potential Wi-Fi hotspots prior to determining whether or not the potential Wi-Fi hotspots are actually communicatively available. In other words, the device may effectively anticipate entering or leaving a particular Wi-Fi hotspot's coverage area and act accordingly. As described above and below, this may include prompting and/or notifying the user or automatically selecting and/or communicatively linking with a particular Wi-Fi hotspot.

As an illustrative example of this, recall FIG. 3 described and shown above where three Wi-Fi networks, each associated with distinct WI-FI APs/hotspots (Wi-Fi AP(s)/hotspots 302, 304 and 306), are discovered/identified in geographical region 300 in the context of the current position of position-determining device 202. In this regard, note that WI-FI AP(s)/hotspot 306 is discovered/identified before position-determining device 202 is within its coverage area. Furthermore, by virtue of the map data on position-determining device 202, surrounding geographical features such as the routes (1 and 2) and POIs (308, 310 and 312) are also identified. As such, the three Wi-Fi networks, the current position of position-determining device 202 and the surrounding geographical features may all be output to the user relative to one another.

Recall from above that a potential Wi-Fi hotspot may be any hotspot that is, or is likely to be available within a certain geographical region designated in the map data. This geographical region may be defined by any suitable means, such as by defining a geographical region having a pre-defined distance/radius surrounding the device's current position or even one or more POIs. As such, at block 408 a determination is made whether at least one potential Wi-Fi hotspot is identified within a defined geographical region. In other words, a determination is made whether any Wi-Fi hotspots are located in (i.e., have all or a portion of a coverage area within) a defined geographical region associated with the device's current position.

If at least one potential Wi-Fi hotspot is not identified, procedure 400 may return back to block 402 again. However, if at least one potential Wi-Fi hotspot is identified, at block 410 a determination is made whether the device is configured to automatically select one or more of the potential Wi-Fi spots. If the device is configured to automatically select one or more of the potential Wi-Fi spots (i.e., “Yes”), procedure 400 proceeds to block 420 described below. However, if the device is not configured to automatically select one or more of the potential Wi-Fi spots (i.e., “No”), block 412 assists user selection of one or more of the potential Wi-Fi hotspots. It is assumed here that a potential Wi-Fi hotspot is selected by the user. However, it should be noted that if a potential Wi-Fi hotspot is not selected, any suitable steps may be taken. For example, procedure 400 may end or may return back to block 402 again. In at least some implementations, assisting the user to select one or more of the potential Wi-Fi hotspots to access may include prompting the user to search for and/or discover available Wi-Fi hotspots, if any (block 414). In other words, the user may be prompted to cause the device's Wi-Fi radio to detect which, if any, of the potential Wi-Fi hotspots are currently available and within a coverage area of a Wi-Fi hotspot. This, however, may not be necessary if the user wishes to select a hotspot that is not communicatively available from the device's current position.

Additionally or alternatively, in at least some implementations, assistance may include prompting the user to select one or more of the potential Wi-Fi hotspots to access (block 416). Prompting may be in response to any suitable pre-defined event, such as when one or more potential Wi-Fi spots are identified at block 406 for instance. Additionally or alternatively, in at least some implementations, assistance may include providing selection-related information to assist the user to select one or more of the potential Wi-Fi hotspots to access (block 418). In this regard, any type of information that is useful to the user to choose a Wi-Fi hotspot is contemplated. In at least some implementations, this selection-related information may be found in the Wi-Fi data, positioning data and/or map data described above. More particularly, this information may include: which identified Wi-Fi AP(s)/hotspot(s) are actually communicatively available, the proximity of individual identified Wi-Fi APs/hotspots to position-determining device 202 and/or one or more points of interest in the geographical region, the proximity of individual identified Wi-Fi APs/hotspots, the cost, if any, of individual identified Wi-Fi APs/hotspots and security/encryption features of individual identified Wi-Fi APs/hotspots.

As an illustrative example of this, again consider FIG. 3 described and shown above. Recall there that position-determining device 202 is configured to provide the user with selection-related information to assist in selecting certain POIs (e.g., POI 308, 310 and 312) as destination points. Also recall that by virtue of this information, the user is able to select POI 308 because they prefer a restaurant serving Italian food with Wi-Fi access. Similarly, and as another example, if POIs 308, 310 and 312 had all been within the coverage area of multiple potential Wi-Fi hotspots, the user could have selected a Wi-Fi hotspot based upon selection-related information provided by position-determining device 202. Without limitation, this information may have included details about relevant geographical feature(s) associated with each potential Wi-Fi hotspot and/or details about each of the Wi-Fi hotspots/networks themselves.

If, at block 410, it is determined that the device is configured to automatically select one or more of the potential Wi-Fi spots (i.e., “Yes”), block 420 automatically selects one or more of the potential Wi-Fi spots for the device to access. It is assumed here that a potential Wi-Fi hotspot is selected. However, it should be noted that if a potential Wi-Fi hotspot is not selected (i.e., user preferences prevent a selection), any suitable steps may be taken. For example, procedure 400 may end or may return back to block 402 again. In at least some implementations, automatic selection may be based on selection-related information and certain stored user preferences. As a very simple illustrative example, again consider again FIG. 3 described and shown above where, in at least some implementations, position-determining device 202 is configured to automatically select based on user preferences which indicate that a free Wi-Fi hotspot should is to be selected if possible.

From the above discussion, note that multiple potential Wi-Fi hotspots (i.e., “one or more potential Wi-Fi hotspots”) may be selected to access. As such, procedure 400 may be associated with planning/calculating a route (with a single way-point or multiple via-points) which includes multiple overlapping and/or non-overlapping Wi-Fi hotspots selected for the device to access while navigation along the route. This might include accessing Wi-Fi hotspots along the route with coverage areas that include all or part of the route or even Wi-Fi hotspots with coverage areas that do not include all or part of the route but that may be reached from some point(s) along the route. Advantageously, this may be performed entirely on the device. Furthermore, by virtue of the device's position-determining functionality, this may be accomplished in the context of the device's current position; with the user being provided turn-by-turn instructions for navigating along the route and/or for navigating from a point along the route to another point within the coverage range of one or more Wi-Fi hotspots.

FIG. 5 depicts a procedure 500 in an exemplary implementation in which a device configured with Wi-Fi and position-determining functionality may facilitate communicatively linking with a selected Wi-Fi hotspot. While a particular Wi-Fi hotspot may be selected by any suitable means, in at least some implementations a selected hotspot is selected according to procedure 400 described and shown above. At block 502, a determination is made whether a device, such as position-determining device 202 for instance, is within range of a selected Wi-Fi hotspot. As described in detail above, the device is within range of a particular selected Wi-Fi hotspot if it is within the coverage area, or transmission range, of the Wi-Fi AP(s) for that Wi-Fi hotspot. If the device is within range of a selected Wi-Fi hotspot (i.e., “Yes”), procedure 500 proceeds to block 506 described below.

If the device is not within range of a selected Wi-Fi hotspot (i.e., “No”), block 504 provides instructions to assist the user in navigating to a position within range of the selected Wi-Fi hotspot. As noted above, this may be performed on the device by integrating the Wi-Fi, positioning and map data in a manner that allows the selected Wi-Fi hotspot and geographical features of the surrounding geographical region to be output/presented to the user with respect to relevant map data. In this way, the device is capable of providing the user with instructions (e.g., turn-by-turn instructions) for navigating to a position within the coverage area of the selected Wi-Fi hotspot. As a simple illustrative example of this, recall FIG. 3 described and shown above where, in at least some implementations, position-determining device 202 is configured to provide the user with turn-by-turn instructions for navigating to a position within the coverage area of Wi-Fi AP(s)/hotspot 306 (e.g., proceed Southward on Route 1).

Continuing, at block 506 a determination is made whether the device is configured to automatically communicatively link with the selected Wi-Fi hotspot. As noted above, communicatively linking may include one or more associative actions taken by the device and/or the Wi-Fi AP(s) of the Wi-Fi hotspot sufficient to allow the device to access the Wi-Fi AP(s) and communicate (i.e., send and/or receive data) via the wireless network associated with the Wi-Fi AP(s). By way of example and not limitation, these actions may include sending/receiving a Wi-Fi AP beacon message, sending/receiving a probe request, sending/receiving a dynamic host configuration protocol (DHCP) request(s) for an internet protocol (IP) address, authenticating with a server associated with the selected hotspot and so on.

If the device is not configured to automatically communicatively link with the selected Wi-Fi hotspot (i.e., “No”), block 508 prompts the user to cause the device to communicatively link with the selected Wi-Fi hotspot. In this regard, the user may cause the device to communicatively link, and thus access a wireless network associated with the Wi-Fi hotspot, through any suitable means, such as interacting with the device via the device's user interface for instance. If the device is configured to automatically communicatively link with the selected Wi-Fi hotspot (i.e., “Yes”), block 510 automatically causes the device to communicatively link with the Wi-Fi hotspot. In such situations, once the device communicatively links and thus accesses a wireless network associated with the Wi-Fi hotspot, the device may be configured to notify the user that the device is communicatively linked and even provide details to the user in this regard.

### CONCLUSION

Although techniques for effectively integrating position-determining functions and Wi-Fi functions have been described in language specific to structural features and/or methodological acts, it is to be understood that the appended claims are not necessarily limited to the specific features or acts described. Rather, the specific features and acts are disclosed as exemplary forms of implementing these techniques.

What is claimed is:

1. A position-determining device comprising one or modules to:
determine a geographic position; and
identify a coverage area for a wireless fidelity (Wi-Fi) hotspot based on the determined geographic position.

2. A position-determining device as recited in claim 1, wherein the position-determining device includes data that comprises:
map data for the determination; and
Wi-Fi data describing the coverage area and location of the Wi-Fi hotspot.

3. A position-determining device as recited in claim 1, wherein the one or more modules are further configurable to facilitate the position-determining device to access the Wi-Fi hotspot.

4. A position-determining device as recited in claim 3, wherein to facilitate the position-determining device to access the Wi-Fi hotspot comprises automatically selecting the Wi-Fi hotspot

5. A position-determining device as recited in claim 3, wherein to facilitate the position-determining device to access the Wi-Fi hotspot comprises one or both of:
prompting a user to select the Wi-Fi hotspot; or
providing information to assist the user to select the Wi-Fi hotspot.

6. A position-determining device as recited in claim 3, wherein to facilitate the position-determining device to access the Wi-Fi hotspot comprises providing navigational instructions from a current position to the determined geographic position that is within the coverage area.

7. A position-determining device as recited in claim 1, wherein the one or modules are further executable to notify a user when the position-determining device is leaving the coverage area.

8. A method comprising:
providing data on a device, the data comprising wireless fidelity (Wi-Fi) data and map data;
calculating, on the device, a current position for the device;
identifying, on the device, one or more Wi-Fi hotspots based on the current position; and
facilitating the device to access at least one of the Wi-Fi hotspots.

9. A method as recited in claim 8, wherein providing comprises one or both of:
downloading, on the device, at least a portion of the data via a Wi-Fi network or wireless cellular network; or
automatically discovering at least a portion of the data via a Wi-Fi radio on the device or another device communicatively linked with the device.

10. A method as recited in claim 8, wherein the Wi-Fi data includes a location and coverage area for individual Wi-Fi hotspots.

11. A method as recited in claim 8, wherein facilitating comprises automatically selecting at least one of the Wi-Fi hotspots for the device to access, wherein automatically selecting is based at least in part on criteria associated with the Wi-Fi data and one or more user preferences.

12. A method as recited in claim 8, wherein facilitating comprises assisting a user to select at least one of Wi-Fi hotspots for the device to access by one or more of:
prompting the user to cause the device to search for individual Wi-Fi hotspots that are communicatively available;
prompting the user to select at least one of the Wi-Fi hotspots; or
providing information to assist the user to select at least one of the Wi-Fi hotspots.

13. A method as recited in claim 12, wherein the information is associated with one or both of:
the Wi-Fi data; or
one or more points of interest in the geographical region.

14. A method as recited in claim 8, wherein facilitating comprises providing navigational instructions to assist a user in navigating to a position within a coverage area of at least one of the Wi-Fi hotspots.

15. A method as recited in claim 8, wherein facilitating comprises one or both of:
prompting a user to cause the device to communicatively link with at least one of the Wi-Fi hotspots; or
automatically communicatively linking the device with at least one of the Wi-Fi hotspots.

16. A method as recited in claim 8, wherein the device comprises a mobile phone configured with global positioning satellite (GPS) functionality.

17. One or more computer-readable storage media comprising instructions that are executable to:
configure a position-determining device to identify a Wi-Fi hotspot prior to determining that the Wi-Fi hotspot is communicatively available, wherein the Wi-Fi hotspot is associated with a coverage area that includes a region, and wherein the region includes the positioning-determining device's current position; and
facilitating the device to access the Wi-Fi hotspot.

18. One or more computer-readable media as recited in claim 17, wherein configuring comprises one or more of:
integrating map data and positioning data on the position-determining device to identify the region;
providing, on the position-determining device, Wi-Fi data for the region, wherein the Wi-Fi data designates the coverage area; or
integrating the map data and the Wi-Fi data to discover the Wi-Fi hotspot.

19. One or more computer-readable media as recited in claim 17, wherein the current position is calculated by the position-determining device.

20. One or more computer-readable media as recited in claim 17, wherein facilitating comprises notifying a user of the Wi-Fi hotspot.

21. One or more computer-readable media as recited in claim 17, wherein facilitating comprises selecting the Wi-Fi hotspot from multiple potential Wi-Fi hotspots identified by the position-determining device.

22. One or more computer-readable media as recited in claim 21, wherein the Wi-Fi hotspot is selected based at least in part on one or more of:
a proximity of the Wi-Fi hotspot to the position-determining device;
a proximity of the Wi-Fi hotspot to one or more points of interest in the region; or
an access cost of the Wi-Fi hotspot.

23. A position-determining device comprising:
a processor;
memory; and
one or modules stored in the memory and executable on the processor to:
calculate a current position for the position-determining device;
identify a route between the current position and a destination position;
identify one or more Wi-Fi hotspot coverage areas along the route; and
depict at least one of the one or more Wi-Fi hotspot coverage areas on a map.

24. A position-determining device as recited in claim 23, wherein the one or more modules are further executable to provide a user with navigational instructions from the current position to the destination position.

25. A position-determining device as recited in claim 23, wherein the one or more modules are further executable to notify a user when the device is entering one or more of the expected coverage areas.
